(19) United States
(12) Patent Application Publication
(10) Pub. No.: US 2003/0086395 A1
(43) Pub. Date: May 8, 2003

(54) System and method for efficient handover in wireless packet data network

(76) Inventor: Vyankatesh Shanbhag, Plano, TX (US)

Correspondence Address: R. Scott Rhoades, Strasburger & Price, L.L.P., Suite 4300, 901 Main Street, Dallas, TX, 75202-3794, US

(21) Appl. No.: 10/289,812

(22) Filed: Nov. 7, 2002

Related U.S. Application Data
(60) Provisional application No. 60/346,340, filed on Nov. 7, 2001.

(51) Int. Cl. H04Q 7/00

(52) U.S. Cl. 370/331

(57) ABSTRACT

A system and method for efficient handoff are presented herein. A wireless content switch is placed in the wireless packet data network and detects initiated handoffs. Responsive thereto, the wireless content switch delays completion at the handoff for a predetermined period of time and causes the content source to temporarily stop transmitting additional packets. Each of the packets that were transmitted prior to temporarily stopping the content source are transmitted to the wireless client during the predetermined period of time that the handoff is delayed. Upon completion of the predetermined period of time, the handoff is permitted to proceed to completion. Because each of the packets transmitted during the pendency of the handoff were transmitted to the wireless client, prior to completion of the handoff, there is no requirement for a tunnel between the donor SGSN and the recipient SGSN, or alternatively, the tunnel can exist for a considerably shorter time than the commonly used 20 seconds. The foregoing results in considerable throughput improvement.

### CROSS-REFERENCE TO RELATED APPLICATIONS

This application claims the priority benefit of U.S. Provisional Application for Patent, Serial No. 60/346,340, entitled “System and Method for Efficient Handover in Wireless Packet Data Network,” filed on Nov. 7, 2001 which is hereby incorporated by reference for all purposes.

### STATEMENT REGARDING FEDERALLY SPONSORED RESEARCH/DEVELOPMENT

Not Applicable.

### FIELD The present invention relates to wireless networks, and more particularly to handoffs in wireless packet data networks.

### BACKGROUND

In the General Packet Radio Service (GPRS) network, a wireless client maintains radio communication with any one of a number of base station systems. Each of the base station systems is connected to a network of nodes, which include Serving GPRS Support Nodes (SGSN) and Gateway GPRS Support Nodes (GGSN). The SGSNs are connected to a group of base station systems and serve the group of base station systems. The GGSN serves as the interface between the Internet and the wireless packet data. The network of SGSNs and GGSNs transmits data packets to wireless clients during data sessions by establishing a tunnel through the network between the GGSN and a particular SGSN. A tunnel represents an allocation of network bandwidth and resources for transmission of the data packets.

Each base station system maintains radio coverage for a particular geographic area known as a cell. As the wireless client traverses one cell and enters a cell associated with another base station, radio communications with the wireless client must be transferred from the base station serving the original cell to a base station serving the new cell. Radio communications are transferred by a process known as a handoff.

A handoff where the base stations associated with the original and new cell are part of the same group served by a single SGSN is known as an intra-SGSN handoff. A handoff where the base stations are part of different groups served by different SGSNs is known as an inter-SGSN handoff. During an inter-SGSN handoff, a tunnel is established between the new SGSN and the wireless client. However, during establishment of the new tunnel, a number of data packets may be transmitted by the content source with routing information through the original SGSN. In order to avoid loss of the data packets, the original tunnel is maintained after the wireless client is handedoff to the new SGSN. Additionally, an inter-SGSN tunnel must also be established between the original SGSN and the new SGSN, wherein data packets transmitted to the original SGSN are forwarded to the new SGSN. Receiving the foregoing data packets requires maintenance of the original tunnel and the inter-SGSN tunnel for a period of time after the handoff is complete. By default, most networks maintain the tunnels for 20 seconds. Maintenance of the original tunnel and the inter-SGSN tunnel after the handoff requires increased consumption of the network resources.

Accordingly, it would be beneficial if the network resource could be more effectively utilized during an inter-SGSN handoff.

### SUMMARY

The present invention is directed to a system and method for transmitting data packets to a wireless client. A wireless content switch detects initiation of the handoff. Upon detection of the initiation of the handoff, the wireless content switch prevents occurrence of the handoff until all of the data packets transmitted by the content source are received and prevents transmission of any additional data packets from the sender. Once receipt of the all the data packets occurs, the wireless content switch releases the signaling required for completion of the handoff.

### BRIEF DESCRIPTION OF THE DRAWINGS

FIG. 1 is a block diagram of a wireless packet data network;

FIG. 2 is a signal flow diagram describing the operation of the wireless network;

FIG. 3 is a block diagram of a GPRS network;

FIG. 4 as a block diagram of an exemplary wireless content switch; and

FIG. 5 is a signal flow diagram describing the operation of the GPRS network.

### DETAILED DESCRIPTION OF THE DRAWINGS

In the descriptions which follow, like parts are marked throughout the specification and drawings with the same numerals, respectively. The drawing figures are not necessarily drawn to scale and certain figures may be shown in exaggerated or generalized form in the interest of clarity and conciseness.

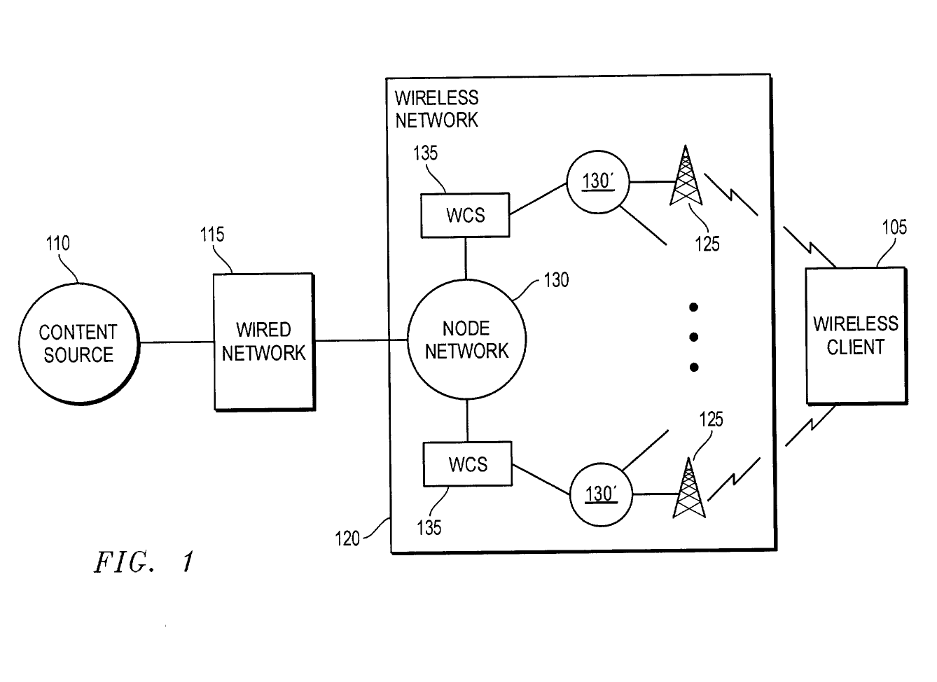

Referring now to FIG. 1, there is illustrated a block diagram of an exemplary wireless packet data network, referenced generally by the numeral designation 100, for transmitting data to a wireless client 105 from a content source 110. The wireless client 105 is a mobile terminal centrally associated with a user or subscriber to the wireless network 120 and can comprise, but is not limited to, a mobile station, a personal digital assistant, a lap top computer, or a palm pilot computer capable of engaging in wireless data communications.

The content source 110 is a server computer which can include, for example, a web server. The content source 110 is generally connected to a wired network 115. The wired network 115 can include, for example, a local area network (LAN), a wide area network (WAN) or the Internet.

The content source 110 transmits data to the wireless client 105 through a series of data packets. The data packets are transmitted over the wired network 115 to the wireless network 120. The wireless network 120 then transmits the data packets to the wireless client 105 over a wireless link over the air interface. Upon receipt of the data packets at the wireless client 105, the wireless client 105 transmits acknowledgements which indicate the last contiguous data packet received.

The wireless network 120 includes any number of base station systems 125 which maintain radio communications with a particular area known as a cell. Together, the base station systems 125 provide radio coverage to a geographic area divided into numerous cells. The base station systems 125 are connected to the wired network 115 by a node network 130. The foregoing node network 130 routes the data packets to the appropriate base station system 125. Each base station system 125 accesses the node network 130 via an initial node 130′. The initial node 130′ is associated with a group of base station systems 125 through which each of the base station systems 125 access the node network 130. A wireless content switch (WCS) 135 is connected between the initial nodes 130′ and the remainder of the node network 130. Connection of the wireless content switch 135 between the initial nodes 130′ and the remainder of the node network 130 permits the wireless content switch 135 to receive signals passed there between.

As the wireless client 105 traverses one cell and enters a cell associated with another base station system 125, radio communications with the wireless client 105 must be transferred from the base station system 125 serving the original cell to a base station system 125 serving the new cell. Radio communications are transferred by a process, known as a handoff. A handoff where the base station systems 125 associated with the original and new cells access the node network 130 through the same initial node 130′ only require transfer at the base station system 125. However, where the base station systems 125 access the node network 130 through different initial nodes 130′, service must be transferred from the initial node 130′ serving the original base station system 125 to the initial node 130′ serving the new base station system 125.

Referring now to FIG. 2, there is illustrated a signal flow diagram describing the operation of the network of FIG. 1 during a handoff requiring transfer of service from one initial node 130′ to another initial node 130′. The handoff is initiated at wireless network 120 (action 205) by transmitting signals pursuant to a handoff procedure which is known to those skilled in the art; such signals include, but are not limited to an Identity Request. Responsive thereto, the wireless content switch 135 detects initiation of the handoff of the wireless client 105 (action 210). The initiation of the handoff is detected by the wireless content switch 135 upon receipt of handoff initiation signals which are transmitted between the original initial node 130′ and the new initial node 130′.

At the time of the handoff initiation, the wireless client 105 has received from the content source 110 packets p(1)-p(I−1). However, before the wireless content switch 135 detects the handoff initiation, the content source 110 has transmitted packets p(I)-p(I+K) which have not yet been received by the wireless client 105. After detection of the handoff initiation, the wireless content switch 135 prevents completion of the handoff (action 215) until the wireless client 105 receives the packets p(I)-p(I+k) and the wireless content switch 135 detects receipt by the wireless client 105 of the data packets (action 225). Detection of receipt of the data packets can occur by, for example, receipt of a signal acknowledging data packet p(I+k). Responsive thereto, the wireless content switch 135 permits the handoff (action 230) to complete. The handoff signaling (signals 235) occurs between the original initial node 130′, the new initial node 130′, and the wireless client 105, thereby completing the handoff.

Referring now to FIG. 3, there is illustrated a block diagram of an exemplary wireless packet data network supporting General Packet Radio Service (GPRS), referenced generally by the numeric reference 300, for facilitating wireless packet data communication with a wireless client 105. It is noted that certain elements have been omitted for the purposes of simplicity and therefore, the FIGURE is not intended as an exhaustive illustration. Pursuant to GSM and GPRS specifications, the wireless network 120 is interfaced with the wired network 115 by any number of Gateway GPRS Support Nodes (GGSN) 305. Each GCSN 305 is associated with any number of IP addresses which the GGSN 305, in turn allocated to the wireless clients 105, either statically or dynamically.

The wireless network 120 provides packet data services to geographical areas which are divided into routing areas. Each routing area is associated with a particular Serving GPRS Support Node (SGSN) 310. Each SGSN 310 is associated with any number of base station systems 312. The base stations systems 312 include the radio transceiver equipment which transmits and receives signals to and from the wireless client 105. Base station systems 312 maintain radio frequency communications within a geographical area known as a cell 320.

The SGSNs 310 and the GGSNs 305 are interconnected by a backbone network 325. The backbone network is a network which may form a portion of the wired network 115 and which routes packet data between the SGSNs 310 and the GGSNs 305. During transmission from the content server 110 to the wireless client 105, the content server 110 transmits the data packets to an IP address associated with the GGSN 305. The GGSN 305 receives the data packet, determines the identity and location of the wireless client 105 associated with the IP address. After determining the location of the wireless client 105, the GGSN 305 determines the SGSN 310 associated with the cell containing the wireless client 105 and forwards the packets to the wireless client 105 over the backbone network 325.

A wireless content switch 135 is associated with each SGSN 310 and is placed between the SGSN 310 and the backbone network 325. In the foregoing manner, the wireless content switch 135 receives all signals that are transmitted between the SGSN 310 and the backbone network 325. The signals include signals which are indicative of an initiated handoff as well as the data packets. The wireless content switch 135 can detect initiation of a handoff by monitoring these signals. When the wireless content switch 135 detects initiation of a handoff of a wireless client 105 from a donor SGSN 310 associated with the wireless content switch 135, the wireless content switch 135 prevents completion of the handoff until all of the packets that have been transmitted by the content source 110 have been received by the wireless client 105. Additionally, the wireless content switch 135 temporarily stops the content source 110 from transmitting additional packets. In one exemplary embodiment, the wireless content switch 135 is an Intelligent Packet Control Node (IPCN) developed and manufactured by Cyneta Networks, Inc.

The foregoing is accomplished by transmission of an acknowledgment signal of the last data packet received by the wireless client 105. The signal also directs the content source 110 to not transmit additional data packets by indicating that a memory buffer at the wireless client 135 is full.

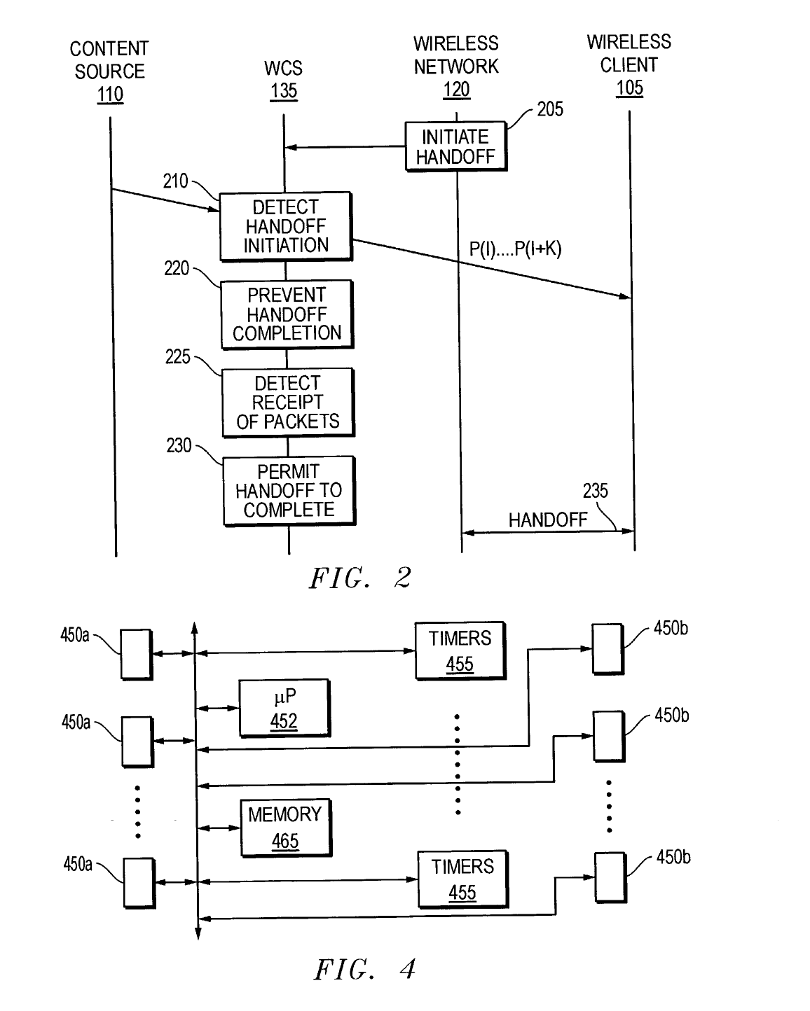

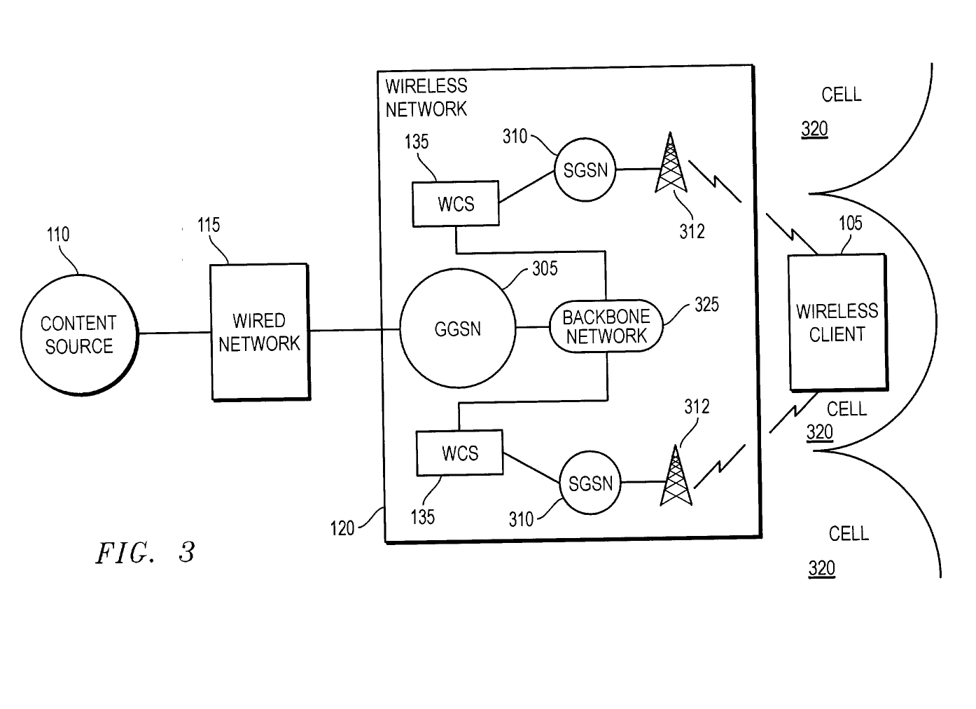

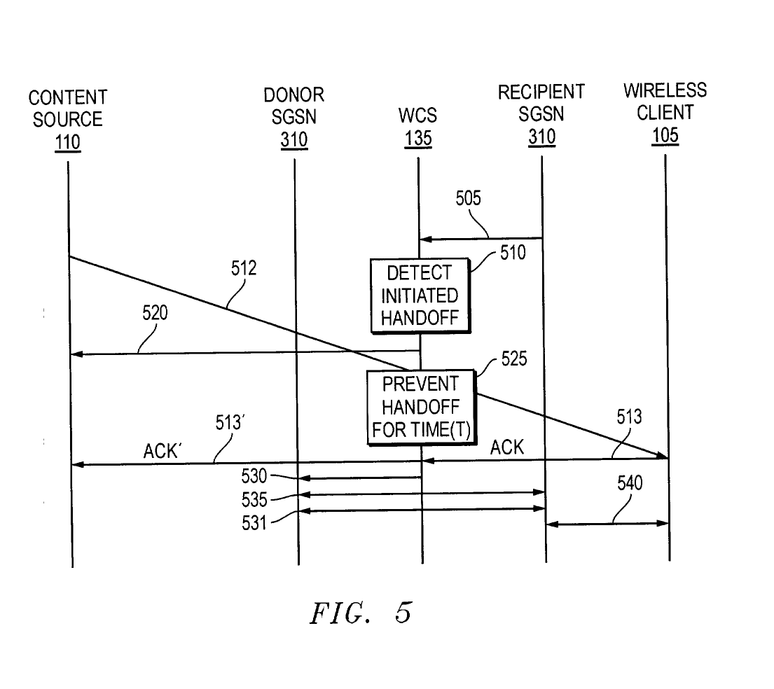

Referring now to FIG. 4, there is illustrated a block diagram of an exemplary wireless content switch 135. The wireless content switch 135 includes any number of upstream ports 450a and downstream ports 450b. The upstream ports 450a facilitate connection of the wireless content switch 135 towards the backbone network 325 and the content source 110 via a data transport mechanism, such as, for example, a T1, E1, or an Ethernet connection to name a few. Connection of the wireless content switch 135 towards the content source 110 and the backbone network 325 via the upstream port 450a permits, at the upstream port 450a, receipt and transmission of data packets, acknowledgments and signals regarding handoff initiation.

Similarly, the downstream ports 450b facilitate connection of the wireless content switch 135 towards the donor SGSN and the wireless client 105 via a data transport mechanism. Connection of the wireless content switch 135 towards the donor SGSN and the wireless client 105 via the downstream port 450b permits receipt and transmission of signals such as acknowledgments, data packets as well as signals completing handoffs.

The wireless content switch 135 also includos a processor 452 and a plurality of timers 455 which are associated with a particular wireless client 105. The foregoing upstream ports 450a, downstream ports 450b, processor 452 and timers 455 are interconnected by means of a bus. Wherein a handoff is initiated for a wireless client 105, a particular one of the plurality of timers 455 is associated with the foregoing wireless client 105. Upon expiration of the timer 455, an interrupt is transmitted to the processor 452 which indicates that the timer associated with an identified wireless client 105 has expired.

Additionally, the wireless content switch 135 includes a memory 465 wherein data packets for the wireless clients 105 can be stored, prior to transmission. The memory 465 can also stored a plurality of executable instructions executable by the processor 452.

The wireless content switch 135 is discussed further in U.S. patent application Ser. No. 09/839,830 entitled “System and Method for Wireless Packet Data Content Switch,” which is commonly owned and assigned with the present application and in U.S. patent application Ser. No. 09/884,663 entitled “Packet Retransmission in Wireless Packet Data Networks,” which is commonly owned and assigned with the present application and both of which are hereby incorporated by reference.

Referring now to FIG. 5, there is illustrated a signal flow diagram describing the operation of the wireless packet data network. A handoff for a wireless client 105 is initiated by transmission of a context request signal from the recipient SGSN 310 to the donor SGSN 310 (signal 505) The foregoing signal is received by the wireless content switch 135 of the associated donor SGSN 310 via the upstream port 450a. Responsive to receiving the context request signal 505, the wireless content switch 135 detects the initiated handoff (action 510) and prevents the content source from transmitting additional data packets by transmitting a signal (signal 520) via upstream port 450a to the content source 110 which indicates that a memory buffer at the wireless client 105 is filled. For example, the wireless content switch 135 can transmit an acknowledgment signal for the last packet received by the wireless client 105, with a window size parameter therein set to zero. This signal 520 causes the content source 110 to temporarily discontinue transmitting data packets to the wireless client 105. Pursuant to the TCP protocol, the acknowledgement signal includes a parameter wherein the recipient of a data packet can indicate that data rate at which it can receive data packets on a dynamic basis. The wireless content switch 125 causes the content source 110 to temporarily discontinue transmitting data packets to the wireless client 105 by setting the receiving window size parameter to indicate a zero value.

Upon receipt of signal 520 with a zero window size, the content source 110 enters what is known as a persist mode. The persist mode is characterized by a period of no transmission for a predetermined amount of time. At the expiration of the predetermined amount of time, the content source 110 transmits a signal addressed to the wireless client 105 which polls the window size for the wireless client 105, known as a window probe. The window probe is received and responded to by the wireless content switch 125 via the wired network 115. Therefore, upon receipt of the window probe signal 535, the wireless content switch 125 transmits a signal 540 via upstream port 450a to the content source 110 maintaining the window size of zero.

Additionally, the wireless content switch 135 prevents completion of the handoff. The wireless content switch 135 prevents completion of the handoff by withholding the context request from the donor SGSN 130 for a predetermined period of time (t) (action 525). The predetermined time is measured by associating a particular one of the plurality of timers 455 with the wireless client 105 and is preferably shorter than the retransmission timeout (RTO) of the content source 110. It is noted that between the time that handoff initiation is detected (action 510) and when the content source 110 receives signal 515, additional data packets may have already been transmitted (signals 512) to the wireless client 105. During the predetermined period of time, each of the data packets that were transmitted to the wireless client 105 are stored at the wireless content switch 135 in memory 465 and forwarded to the wireless client 105 via the donor SGSN 310. As each data packet is received, the wireless client 105 transmits acknowledgment signals (signals 513) towards the content source 110. Each of the acknowledgment signals 513 include a window size indicating buffer availability at the wireless client 105. The acknowledgment signals 513 are received at the wireless content switch 135 via downstream port 450b en route to the content source 110. The wireless content switch 135 changes the window size to indicate that the buffer at the wireless client 105 is exhausted and transmits the acknowledgment signal 513′ via upstream port 450a to the content source 110. At the completion of the predetermined period of time, the timer associated with the wireless client 105 expires and transmits an interrupt to the processor 452. Responsive thereto, the wireless content switch 135 releases and transmits the context request via downstream port 450a to the donor SGSN 310 (signal 530). When the donor SGSN 310 receives the context request, the donor SGSN 310 transmits a context response (signal 535) to the recipient SGSN 310. Upon receipt of the context response signal 535 at the recipient SGSN 310, the handoff is completed and the wireless client 105 can continue communication via the recipient SGSN 310 (signal 540). When the last acknowledgement signal is received by the donor SGSN 310, this signal is transmitted to the content server 110 with a non-zero window size to alert the content server 110 to continue sending data packets to the wireless client 105. There is no requirement of establishing a donor SGSN/recipient SGSN tunnel because the handoff is prevented from completion until after each of the data packets transmitted to the wireless client 105 has been received. Alternatively, the donor SGSN/recipient SGSN can form a tunnel (action 537) for a considerably shorter time period than the standard 20 seconds that is commonly used.

Although the foregoing detailed description describes certain embodiments with a degree of specificity, it should be noted that the foregoing embodiments are by way of example, and are subject to modifications, substitutions, or alterations without departing from the spirit or scope of the invention. Accordingly, the invention is only limited by the following claims, and equivalents thereof.

What is claimed is:

1. A method for transmitting data packets to a wireless client, said method comprising:
detecting a handoff request associated with the wireless client; and
delaying the handoff for a predetermined period of time.

2. The method of claim 1, wherein detecting a handoff request further comprises:
receiving a signal from a recipient node.

3. The method of claim 2, wherein receiving a signal from a recipient node further comprises:
receiving a context request from a recipient SGSN.

4. The method of claim 1, wherein delaying the handoff for a predetermined period of time further comprises:
delaying the handoff until one or more data packets are received at the wireless client.

5. The method of claim 4, further comprising:
storing the one or more data packets.

6. The method of claim 1, further comprising:
preventing a content source from transmitting additional packets to the wireless client until the handoff is completed.

7. The method of claim 6, wherein preventing the content source from transmitting additional packets further comprises:
transmitting a signal to the content source, said signal causing the content source to stop transmitting data packets to the wireless client; and
transmitting a signal to the content source causing the content source to continue transmitting data packets to the wireless client responsive to completion of the handoff.

8. The method of claim 6, wherein preventing the content source transmitting additional packets further comprises:
transmitting an acknowledgment to the content source, said acknowledgment including a window size of zero; and
transmitting a signal to the content source responsive to completion of the handoff, said signal including a non-zero window size.

9. The method of claim 1, further comprising:
notifying the content source transmitting the the data packets of the handoff.

10. A wireless content switch for transmitting data packets to a wireless client, said method comprising:
a first port for receiving a handoff request associated with the mobile station;
a timer for measuring a predetermined period of time responsive to receiving the handoff request at the first port; and
a second port for transmitting the handoff request responsive to expiration of the predetermined period of time.

11. The wireless content switch of claim 10, wherein the first port receives a signal from a recipient node.

12. The wireless content switch of claim 11, wherein the first port receives a context request from a recipient SGSN.

13. The wireless content switch of claim 10, further comprising:
a third port for transmitting a signal which prevents a content source from transmitting additional packets to the mobile station until the handoff is completed.

14. The wireless content switch of claim 13, wherein the third port transmits an acknowledgment to the content source, said acknowledgment including a window size of zero.

15. The wireless content switch of claim 14, wherein the third port transmits a signal notifying the content source of the handoff.

16. The wireless content switch of claim 14, further comprising:
memory for scoring data packets transmitted by the content source.

17. A wireless network system for use with a wired network including a content provider, the wireless network system comprising:
a first type node, the first node interfacing the wireless network system to the wired network system;
a plurality of second type nodes coupled to the first type node, each of the second type nodes including a transceiver for transmitting and receiving wireless signals in a cell;
a wireless client in wireless connection with at least one of the second type node's transceiver;
a plurality of wireless content switches located between each of the second type nodes and the first type node, each wireless content switch comprising:
upstream ports in communication with the first type node;
downstream ports in communication with the second type node;
a processor coupled to the upstream ports and the downstream ports;
a memory coupled to the processor;
handoff code stored in the memory, the handoff code, when executed performing the following steps:
determining if a handoff initiation is requested;
if a handoff is requested, transmitting a prevent data packet transmission signal to the content provider and withholding transmission of the handoff initiation request to the second type node;
transmitting remaining data packets to the wireless client;
determining if all remaining data packets have been received by the wireless client; and
if all remaining data packets have been received, transmitting the handoff initiation request to the second type node and transmitting a continue transmitting data packets to the content provider.

18. The wireless network system of claim 17, wherein the step of transmitting a prevent data packet transmission signal to the content provider includes transmitting a data packet acknowledgement with the window size set to zero.

19. The wireless network system of claim 17, wherein the step of transmitting a continue transmitting data packets to the content provider includes transmitting a data packet acknowledgement with the window size set to non-zero.

20. The wireless network system of claim 17, wherein the first type node is a gateway node and the second type nodes are serving nodes.
